(19) United States
(12) Patent Application Publication
(10) Pub. No.: US 2006/0090586 A1
(43) Pub. Date: May 4, 2006

(54) Pop-up prevention structure for steering columns

(75) Inventor: Byeong-Hoon Lee, Kyunggi-do (KR)

Correspondence Address: GREENBLUM & BERNSTEIN, P.L.C., 1950 ROLAND CLARKE PLACE, RESTON, VA, 20191, US

(73) Assignee: Hyundai MOBIS Co., Ltd., Yongin-shi (KR)

(21) Appl. No.: 11/008,214

(22) Filed: Dec. 10, 2004

(30) Foreign Application Priority Data
Nov. 3, 2004 (KR) 10-2004-0088595

(51) Int. Cl. B62D 1/16

(52) U.S. Cl. 74/492

(57) ABSTRACT

Disclosed herein is a pop-up prevention structure for steering columns. This invention employs frictional force obtained by horizontally tightening a tilt lever and the engagement of a fixed gear with a movable gear, thus preventing a steering column from undesirably popping up when a vehicle is in a collision, therefore minimizing injury to a driver.

### RELATED APPLICATIONS

The present disclosure relates to subject matter contained in priority Korean Application No. 10-2004-0088595, filed on Nov. 03, 2004, which is herein expressly incorporated by reference in its entirety.

### BACKGROUND OF THE INVENTION

1. Field of the Invention

The present invention relates generally to steering apparatuses for vehicles and, more particularly, to a pop-up prevention structure for steering columns, capable of maintaining the capability of absorbing impact energy by preventing pop-up of a steering column, namely, upward displacement thereof, when a vehicle is in a collision.

2. Description of the Related Art

Generally, a steering apparatus is used to change a moving direction of a vehicle as desired, while the vehicle is running. The steering apparatus includes a steering wheel manipulated by a driver, and a steering shaft and a steering column which transmit a driver's steering force to both a steering gear mechanism and a link mechanism. In this case, the steering gear mechanism reduces the rotation speed of the steering shaft and transmits it to the link mechanism.

Further, the steering apparatus is provided with a steering column tilt assembly to control the position of the steering column, thus allowing a driver to appropriately adjust the angle of the steering wheel according to his/her size or preference.

FIG. 1a is a schematic view to show a conventional steering column tilt assembly, and FIG. 1b is a sectional view taken along line A-A′ of FIG. 1a.

As shown in FIG. 1a, the conventional steering column tilt assembly 1 is installed to support a steering column 50 having a steering shaft 26 therein. The steering column tilt assembly 1 includes a tilt bracket 20 and a tilt lever 30 mounted to an outer surface of the tilt bracket 20. The steering column tilt assembly 1 is operated to tilt the steering column 50 upwards or downwards by rotating the tilt lever 30 to tighten or loosen a screw, thus allowing a driver to adjust an angle of the steering wheel 24 as desired.

The construction of the steering column tilt assembly 1 will be described in detail with reference to FIG. 1b. That is, a support bracket 40 is mounted to a lower end of the steering column 50 surrounding the steering shaft 26. The support bracket 40 and the steering column 50 are insalled to be surrounded by the ‘U’-shaped tilt bracket 20 which is mounted at an upper end thereof to a vehicle body 10 and has predetermined elasticity.

That is, an adjusting bolt 32 is inserted into guide slots 22 which are formed on both side surfaces of the tilt bracket 20 such that the adjusting bolt 32 horizontally passes through the tilt bracket 20 and the support bracket 40. The tilt lever 30 is screwed to an end of the adjusting bolt 32.

Thus, as shown in FIG. 1a, when the tilt lever 30 is rotated at a predetermined angle to move from an initial locking position L to an unlocking position R so that a driver may adjust the angle of the steering column 50, the tilt lever 30 is rotated in a direction to be released from the adjusting bolt 32. At this time, both side surfaces of the tilt bracket 20, which are elastically compressed against both side surfaces of the support bracket 40, return to original positions thereof, so that the tilt bracket 20 is spaced apart from the support bracket 40 by a predetermined distance. In such a state, the support bracket 40 which supports the steering column 50 is movable upwards and downwards.

Subsequently, the driver adjusts the position of the steering wheel 24 as desired. Next, the tilt lever 30 is rotated again to the initial locking position L. At this time, the side surfaces of the tilt bracket 20 are elastically compressed to come into close contact with the side surfaces of the support bracket 40, thus locking the support bracket 40. Thereby, the tilt adjustment operation of the steering column 50 is completed.

However, the conventional steering column tilt assembly employs a friction locking method using contact force between the support bracket 40 and the tilt bracket 20. Thus, assuming that the contact force between the support bracket 40 and the tilt bracket 20 is reduced, and thereby the coupling of the support bracket 40 with the tilt bracket 20 is loosened, the steering wheel 24 may pop up due to an impact which is generated when a driver collides with the steering wheel 24 due to the collision of the vehicle. When the steering wheel 24 pops up, a deployment position of an air bag installed in the steering wheel 24 is changed, so that it is impossible to efficiently absorb impact energy. Thereby, occupants riding in the vehicle may be severely injured.

### SUMMARY OF THE INVENTION

Accordingly, the present invention has been made keeping in mind the above problems occurring in the prior art, and an object of the present invention is to provide a pop-up prevention structure for steering columns, which employs a locking method using engagement of a fixed gear with a movable gear as well as a friction locking method using a lateral force fastening a tilt lever, thus preventing a steering column from popping up when a vehicle is in collision and a large load is applied to a steering wheel, therefore efficiently absorbing the impact energy of the vehicle and minimizing the injury to occupants riding in the vehicle.

In order to accomplish the above object, the present invention provides a pop-up prevention structure for a steering column, including a tilt bracket to support the steering column; a bolt fastened to the tilt bracket by horizontally passing through the tilt bracket; a tilt lever rotatably tightened to an end of the bolt; a fixed gear mounted to the tilt bracket; and a movable gear interposed between the tilt lever and the tilt bracket to engage with the fixed gear, the movable gear being rotatably fitted over the bolt.

The movable gear has at a predetermined position thereof a locking protrusion, and the tilt lever has at a predetermined position thereof a stopper so that the locking protrusion of the movable gear is stopped by the stopper of the tilt lever during rotation of the tilt lever.

The pop-up prevention structure further includes a spring to elastically bias the movable gear toward the fixed gear.

In this case, a first end of the spring is supported by passing through an end of the bolt which is positioned outside the tilt lever, and a second end of the spring is supported by an upper end of the movable gear.

### BRIEF DESCRIPTION OF THE DRAWINGS

The above and other objects, features and advantages of the present invention will be more clearly understood from the following detailed description taken in conjunction with the accompanying drawings, in which:

FIGS. 1a and 1b are schematic views to show a conventional steering column tilt assembly for vehicles;

FIG. 2 is a view to show the construction of a steering column tilt assembly, according to an embodiment of the present invention;

FIG. 3 is a side view to show the steering column tilt assembly shown in FIG. 2; and

FIG. 4 is a view to show the operation of the steering column tilt assembly, according to the present invention.

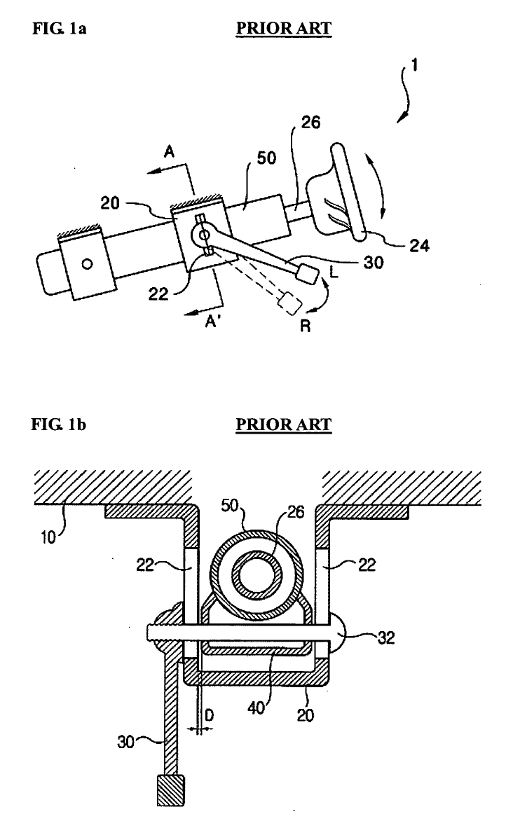

### DESCRIPTION OF THE PREFERRED EMBODIMENTS

Hereinafter, a preferred embodiment of the present invention will be described in detail with reference to the accompanying drawings.

The construction common to both the prior art and the present invention will not be described in detail, but the features of the present invention will be described in detail below. Further, the same reference numerals are used throughout the different drawings to designate the same components.

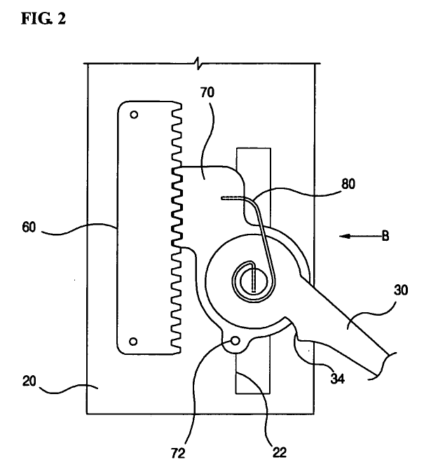

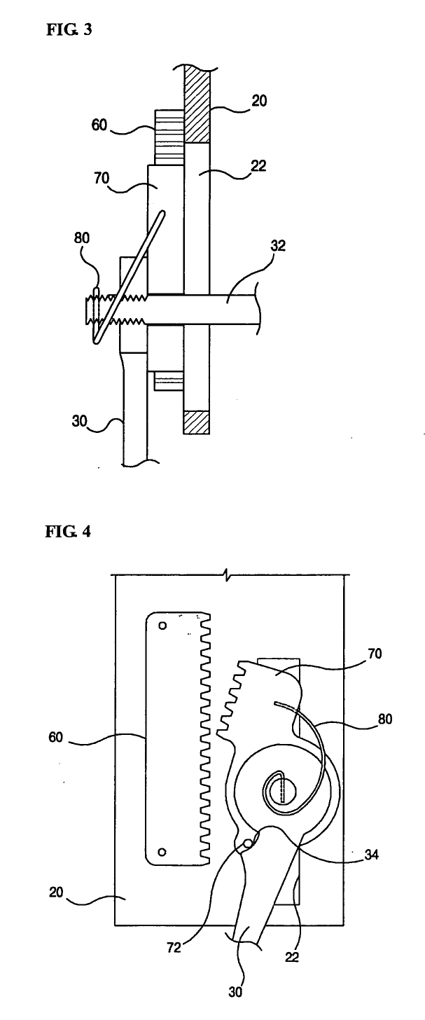

FIG. 2 shows a steering column tilt assembly, according to an embodiment of the present invention, and particularly illustrates a side of a tilt bracket. Further, FIG. 3 is a view shown from B direction of FIG. 2, and FIG. 4 is a view to show the operation of the steering column tilt assembly of FIG. 2.

As shown in FIGS. 2 to 4, the steering column tilt assembly includes a tilt bracket 20, with guide slots 22 longitudinally bored on both side surfaces of the tilt bracket 20. A bolt 32 is horizontally inserted through the guide slots 22 to be fastened to a support bracket (not shown) which supports a lower surface of a steering column.

Further, a threaded part is machined on an outer circumference of an end of the bolt 32. A tilt lever 30 engages with the threaded part of the bolt 32, so that the tilt lever 30 is tightened to or loosened from the bolt 32 by the rotation of the tilt lever 30.

In a detailed description, when the tilt lever 30 is rotated in a counterclockwise direction, the interval between the tilt bracket 20 and the support bracket (not shown) is reduced. In this case, a locking state is maintained such that the steering column may not be tilted. Conversely, when the tilt lever 30 is rotated in a clockwise direction, the interval between the tilt bracket 20 and the support bracket is increased. In this case, the locking state is released, so that it is possible to tilt the steering column upwards and downwards.

According to the present invention, a fixed gear 60, having teeth along a side edge thereof, is mounted to a side surface of the tilt bracket 20 to be parallel to the guide slots 22. Further, a movable gear 70 is interposed between the tilt lever 30 and the tilt bracket 20 to correspond to the fixed gear 60. The movable gear 70 has at an upper end thereof teeth to engage with the teeth of the fixed gear 60.

The movable gear 70 has at a rotational center thereof a through hole 71 to be fitted over the bolt 32. Further, the movable gear 70 is constructed to rotate about the bolt 32.

When the steering column is tilted, the bolt 32 moves upwards and downwards along the guide slots 22, so that the tilt lever 30 and the movable gear 70 coupled to the bolt 32 are operated in conjunction with the bolt 32.

Further, a locking protrusion 72 having a predetermined width is provided at a lower end of the movable gear 70.

A stopper 34 is provided at a predetermined position on the tilt lever 30 to correspond to the locking protrusion 72, so that the locking protrusion 72 is stopped by the stopper 34 when the tilt lever 30 is rotated in the clockwise direction to unlock the steering column.

Thus, when the tilt lever 30 is unlocked, as shown in FIG. 4, the stopper 34 of the tilt lever 30 pushes up the locking protrusion 72 of the movable gear 70, so that the movable gear 70 is forced to rotate about the bolt 32. Thereby, the movable gear 70 disengages from the fixed gear 60.

The steering column tilt assembly according to the present invention further includes a spring 80. The spring 80 provides a predetermined elastic force to the movable gear 70 to normally maintain the engagement of the movable gear 70 with the fixed gear 60.

Preferably, an end of the spring 80 is bent and inserted into a spring support hole 36 that is formed in an end of the bolt 32 which is positioned outside the tilt lever 30. Further, the other end of the spring 80 is coupled to and supported by an upper portion of the movable gear 70.

Such a construction allows the spring 80 to continuously bias the movable gear 70 toward the fixed gear 60. Further, a spring support structure provided at the end of the bolt 32 prevents the tilt lever 30 from being removed from the bolt 32 without an additional nut.

The operation of this invention constructed as described above will be described in detail with reference to the accompanying drawings.

At normal times, as shown in FIGS. 2 and 3, the tilt lever 30 tightens the tilt bracket 20 while pushing the movable gear 70 in an axial direction of the bolt 32, so that vertical displacement of the steering column is prevented due to frictional force between the tilt bracket 20 and the support bracket (not shown).

Moreover, the movable gear 70 engages with the fixed gear 60. Thus, although the frictional force acting between the tilt bracket 20 and the support bracket is reduced, undesirable pop up of the steering column is prevented.

In such a state, when a driver wishes to tilt the steering column, the tilt lever 30 is rotated in a clockwise direction, as shown in FIG. 4. At this time, a force which acts to tighten the movable gear 70 in the axial direction of the bolt 32 is eliminated, so that the frictional force acting between the tilt bracket 20 and the support bracket is eliminated.

Thus, the stopper 34 of the tilt lever 30 pushes up the locking protrusion 72 of the movable gear 70 while rotating the movable gear 70 in the clockwise direction. Thus, the movable gear 70 disengages from the fixed gear 60, so that it is possible to tilt the steering column.

In such a state, when the driver wishes to lock the steering column again, the tilt lever 30 is rotated in the counterclockwise direction. At this time, the locking protrusion 72 of the movable gear 70 is released from the stopper 34 of the tilt lever 30. Further, the movable gear 70 is biased toward the fixed gear 60 by a restoring force of the spring 80, thus engaging with the fixed gear 60.

According to the present invention, when the tilt lever 30 is completely tightened by the bolt 32, the movable gear 70, the tilt bracket 20, and the support bracket are in frictional contact with each other due to the bolt 32, thus preventing undesirable separation of the movable gear 70, the tilt bracket 20, and the support bracket.

As described above, the present invention accomplishes the following effects.

First, the present invention employs frictional force acting between a movable gear, a tilt bracket, and a support bracket by axially tightening a bolt into a tilt lever, and besides, engages a movable gear with a fixed gear, thus preventing a steering column from undesirably popping up, despite large force acting on the steering column.

Thus, unlike the prior art, the present invention prevents a deployment position of an air bag from being changed due to the pop-up of the steering column, so that the air bag effectively absorbs impact energy of a vehicle, thus considerably reducing the injury to a driver.

Second, a spring is installed to bias the movable gear toward the fixed gear, so that the engagement of the movable gear with the fixed gear is maintained when it is unnecessary to manipulate a tilt lever, thus preventing the steering column from popping up.

Further, although the movable gear disengages from the fixed gear due to the rotation of the tilt lever, the movable gear returns to an original position thereof and engages with the fixed gear due to the spring without the necessity of an additional manipulation.

Third, an end of the spring passes through and is supported by an end of the bolt which is positioned outside the tilt lever, thus preventing the tilt lever from being removed from the bolt without providing a nut.

Fourth, a locking protrusion is provided at a predetermined position on the movable gear and a stopper is provided at a predetermined position on the tilt lever so that the movable gear is rotated by the rotation of the tilt lever, thus achieving a simple mechanical construction and allowing a tilt adjustment operation of the steering column to be easily performed.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A pop-up prevention structure for a steering column, comprising:
a tilt bracket to support the steering column;
a bolt fastened to the tilt bracket by horizontally passing through the tilt bracket;
a tilt lever rotatably tightened to an end of the bolt;
a fixed gear mounted to the tilt bracket; and
a movable gear interposed between the tilt lever and the tilt bracket to engage with the fixed gear, the movable gear being rotatably fitted over the bolt.

2. The pop-up prevention structure as set forth in claim 1, wherein the movable gear has at a predetermined position thereof a locking protrusion, and the tilt lever has at a predetermined position thereof a stopper so that the locking protrusion of the movable gear is stopped by the stopper of the tilt lever during rotation of the tilt lever.

3. The pop-up prevention structure as set forth in claim 1, further comprising:
a spring to elastically bias the movable gear toward the fixed gear.

4. The pop-up prevention structure as set forth in claim 2, further comprising:
a spring to elastically bias the movable gear toward the fixed gear.

5. The pop-up prevention structure as set forth in claim 3, wherein a first end of the spring is supported by passing through an end of the bolt which is positioned outside the tilt lever, and a second end of the spring is supported by an upper end of the movable gear.
